(19) United States
(12) Patent Application Publication
(10) Pub. No.: US 2007/0137579 A1
(43) Pub. Date: Jun. 21, 2007

(54) Cowshed arrangement and cowshed unit for housing dairy cattle

(76) Inventors: Uwe Osthues, Mende-Bosperde (DE); Michael Schomaker, Oelde (DE)

Correspondence Address: Jeffry W Smith;Smith Law Office, 440 Science Drive Ste 302, Madison, WI, 53711, US

(21) Appl. No.: 10/565,061

(22) PCT Filed: Jul. 8, 2004
(86) PCT No.: PCT/EP04/07466

§ 371 Date: Jul. 18, 2006

(30) Foreign Application Priority Data
Jul. 16, 2003 (DE) 10332418.6

(51) Int. Cl. A01J 5/00

(52) U.S. Cl. 119/14.03

(57) ABSTRACT

The invention relates to a cowshed arrangement with a central region (1) and with balding regions (3), arranged around the central region (1). According to the invention, a larger number of animals can be housed in the cowshed arrangement and milked, whereby at least one milking region (4) runs in an essentially radial direction.

The object of the patent application refers to a cowshed arrangement as well as to a cowshed unit for housing dairy cattle.

Different cowshed concepts have been developed for housing dairy cattle. For large herds of dairy cattle frequently the pen barn is chosen as keeping method. The essential advantages of a pen barn are rational working economy and housing conditions proper for the animals. Dairy cattle, which can be cows, can freely move in a pen barn. As a result of this the stall can be divided into various regions which are adjusted to the requirements of man and animals.

Within a cowshed arrangement, bedding areas are provided for the animals. The bedding areas can be deep stalls with litter or high stalls with mats, especially rubber mats. For the purpose of bedding comfort and to increase the walking safety, the mats can be provided with a light litter. The bedding areas are sized to provide unhindered lying down, resting and standing up. The bedding area can be subdivided into numerous bedding areas by separation of the stalls proper for the animals. It is also known that, for example, there is no subdivision in the stalls in a so-called two-surface stall with a littered bedding area.

In addition to the bedding areas, the cowshed arrangement comprises at least one milking area, where the animals are milked. For example, a milking area is known from DE 37 02 465 A1 which includes an automatic milking system. The milking area is provided in a cowshed arrangement which has an essentially rectangular ground plan. Here the milking area is outside of and essentially next to one of the front faces of the cowshed arrangement.

In addition to cowshed arrangements with an essentially rectangular ground plan, stall arrangements with an essentially circular ground plan are also known. Such a cowshed arrangement is described, for example, in U.S. Pat. No. 4,254,736, DE 102 00 254 A1 and WO 02/19807.

A carousel milking installation is known from WO 02/19807. The carousel milking installation has several milking stations where cows can be milked simultaneously. The milking stations are arranged on a rotating floor.

If the cowshed arrangement according to WO 02/19807 is established according to size, that is, according to the number of available milking stations and bedding areas, then increase of the herd can only occur within a narrow range.

If the dairy operation would wish to increase the herd significantly, it becomes necessary to provide a further cowshed arrangement in addition to the existing cowshed arrangement.

Based on this, the goal of the present invention is to further develop a cowshed arrangement with a central region and with bedding areas which are arranged around a central region.

This task is solved according to the invention by a cowshed arrangement with the characteristics of claim 1. Advantageous further developments and embodiments of the cowshed arrangement are the objects of the dependent claims.

The cowshed arrangement according to the invention has a central region and bedding areas which are arranged around the central region. At least one milking area is provided within the cowshed arrangement. At least one milking area extends essentially in a radial direction.

As a result of the fact that the milking area extends essentially in a radial direction, the possibility is created to adjust the cowshed arrangement to an increasing number of animals which can be housed and milked in the cowshed arrangement. First of all there is the possibility to increase the number of bedding areas until the limit is reached for the maximum number of animals which can be milked within a predetermined time span. In addition there is the possibility of expanding the milking area so that a higher throughput of animals is achieved.

The cowshed arrangement according to the invention can make it possible for it to be expanded or for the cowshed arrangement to be reduced when the number of animals is reduced.

The bedding areas as well as the milking areas can be designed as modules so that these modules can be combined to the desired cowshed arrangement. The modular design also permits the possibility of expanding already-existing cowshed arrangements.

Preferably one or several standard sizes of the cowshed arrangement are provided. Then the possibility arises to reuse the planking elements of the platform and the planking elements to produce the bedding areas. The use of modular stalls (for example, made of finished parts) is also preferred in order to provide a flexible possibility of expansion.

The cowshed arrangement according to the invention is suitable especially for dairy cattle operations in which the milking area has an automatic milking system. An automatic milking system provides an outstanding integration into the cowshed arrangement according to the invention. In an automatic milking system the milking process itself is automated.

The animals within the cowshed arrangement can move around freely. In order to avoid that the paths of the animals end in dead-ends, it is proposed that the milking area have at least one passageway.

If a directed a selectively directed traffic is desired, then it is proposed that the passageway have at least one gate which is opened and closed automatically. The opening or closing of the passageway can be done as a function of an animal which approaches the passageway. For example, animals which are not supposed to have more than a predetermined number of milking times are simply allowed to pass through the milking system.

Hereby it is proposed that at least one identification device be provided which is intended for the identification of individual animals. The identification device includes, for example, a transmitter and a receiver, where the animal carries a corresponding opposing part so that identification of the animal becomes possible.

Preferably a flexible cowshed arrangement to adjust to a different herd size can be achieved.

According to a further advantageous embodiment of the cowshed arrangement, it is proposed that at least one selection sector is provided. Preferably, the selection sector is arranged neighboring the milking area. Selection of the animals takes place in the selection sector to determine if the animals can enter the milking area or are to be led away from the milking area. Whether or not an animal may enter the milking area or not can depend on different factors. This can be, for example, a time duration that elapsed since the last milking process. For example, if the animal is recognized as not ready for milking, then it is led away from the milking area by means of the selection sector. On the other hand, animals that are recognized as ready to be milked or overdue are directed to the milking area.

The animals can move freely within the cowshed arrangement. For this purpose, at least one gangway is provided extending in a peripheral direction. Depending on the manure removal method, for example, the gangway can be equipped with slatted floors for automatic manure removal into the liquid manure channels lying under it. The gangways are to be dimensioned so that the animals can go by each other without any fear from higher-ranked animals.

In order to provide possibilities to the animals for avoiding each other, it is proposed that the cowshed arrangement have at least one pathway extending essentially in the radial direction. Preferably the pathway connects at least two gangways. Especially it is proposed that the pathways extend from the central region to the edge region of the cowshed arrangement.

The gangways and/or pathways can also be provided with gates. The opening and closing of the gates is preferably performed automatically. By means of the opening and closing of the gates a directed animal traffic can be achieved within the cowshed arrangement. Such a measure has the advantage that a better distribution of the animals in front of the milking area is achieved.

According to an even more advantageous further development of the cowshed arrangement, it is proposed that a feeding area be provided between two neighboring bedding areas. In the feeding area, the feed mixture can be offered in reserve and no longer selected so that a special feeding place for the individual animal is not necessary. This measure permits flexible structural solution of the cowshed arrangement. As a result of the fact that a feeding area is provided between two neighboring bedding areas, animal keeping appropriate for the species can be achieved.

In addition to or instead of the feeding areas between two neighboring bedding areas, it is proposed that a feeding area be provided in the edge region of the cowshed arrangement. If the feeding area is an additional area, then, for example, in this feeding area a concentrate can be provided. The issuance of the concentrate can be done related to performance, with animal identification at the concentrate stations, which are arranged in the feeding area. The issuance of feed is preferably done automatically with the aid of a feed issuance device.

In addition to providing feed in the feeding area, the feeding area can also be equipped with drinking supplies, especially automatic drinking supplies, in order to cover the water demand of the animals. The drinking supplies should be arranged especially so that the animals have free access to the drinking supply after milking.

Especially in cowshed arrangements which have at least one automatic milking system, there is a possibility that the animals can visit the automatic milking system any time. Experience has shown that a number of animals do not visit the milking station or visit it at very large time intervals so that these animals become overdue with regard to a milking process. In order to avoid this, it is known that in the case of automatic milking with free animal traffic, overdue animals can be manually separated and driven to the milking system. This procedure has its limitations in the case of large animal herds with hundreds of animals, since even just finding the overdue animals is very expensive with regard to personnel.

Therefore, in a further advantageous embodiment of the cowshed arrangement, it is proposed that it has at least one driving device. With the aid of the driving device, the animals are driven to the milking area and are then milked.

Preferably the driving device operates automatically. Especially it is proposed that the driving device drive the entire animal stock located in the cowshed arrangement to milking two or three times a day. If the cowshed arrangement has a selection sector, then the animals are driven to the milking system with the aid of the driving device with consideration of the times between milkings.

For this purpose, first of all the individual characteristics of the animals in a herd are determined and stored. From these determined characteristics, at least one interim milking period is determined for the herd. During the interim milking period, the animals have no possibility of visiting the milking area freely, so that the animals are always introduced to a milking process at predetermined times. As a result of this measure, the animals become accustomed to regular milking times, which is related to positive influences on the health of the udder and the performance of the animals. Such a cowshed arrangement also has the advantage that the milking system has a higher utilization, which is advantageous for economical reasons.

For the purpose of driving the animals it is proposed that at least one milking area and the driving device can be moved relative to one another. An especially simple and cost-effective construction of a cowshed arrangement can be realized by having at least one milking area located in a fixed position and have the driving device be mobile.

Depending on the conditions and requirements of the cowshed arrangement, it may also be expedient that at least one milking area be mobile and the driving device be at a fixed location. Combinations of movements both of the milking area as well as of the driving device are also possible.

In order to drive the animals within the cowshed arrangement, the driving device has at least one driving unit which can be moved around the central region, looking at it from the peripheral direction, especially it can be swiveled, preferably rotated. The design of the driving device and of at least one driving unit is adjusted especially to the ground plan of the cowshed arrangement as well as to the position of the bedding areas, of the gangways and pathways.

It can also be expedient to provide a waiting region before the milking area, which preferably is a part of the selection sector. As a result of this measure, better distribution of the animals within the milking area is achieved. Nonuniform utilization of the milking area which has several milking stations is avoided. Nonuniform utilization would occur when certain milking stations would be frequented more often than other milking stations, since the occurrence of animals looking at it from the radial direction is distributed differently.

The driving device is driven with the aid of a driving unit. Preferably this is a controllable driving unit so that the speed with which the driving device operates can be controlled. The concept “controllable” also includes here the possibility of controlling the speeds with which the driving device is operated. The control quantities hereby can be the individual data of the animals, the data of the milking area, the number of animals within the cowshed arrangement, as well as other characteristics.

During the driving process the driving device moves from an initial position to an end position. In order for it to be able to assume the initial position again, the driving device can be moved backwards, but then during the backward movement preferably no driving activity is performed.

In order to simplify the construction of the driving devices as well as to control the driving device, it is proposed that the driving device and/or at least one milking area be designed in such a way that the driving device and at least one milking area can be moved past each other. Hereby, for example, the driving device can be moved beyond the milking area. In this way it is ensured that during the travel of the driving device over the milking area the driving device does not collide with the milking area.

A collision can be avoided, for example, by the fact that at least one driving unit or the driving device as a whole is lifted up so that it can be moved beyond the milking area without touching it. Alternatively, for example, the driving unit can be swiveled around an essentially vertical axis, whereby the milking area has passages through which the driving unit can be passed.

In the case of systems in which the milking area and a driving device are provided and these are moveable with respect to one another, in preferred further developments it is provided that at least some rinsing times of the milking installation can be triggered as a function of the system parameters. Preferably, a rinsing time is triggered when the driving device and the milking area pass one another, since at this point no animal is being milked and thus a clean installation is made available for the next round.

In order to provide good prerequisites for the health of the animals in the cowshed arrangement, especially for the health of the hooves and the secure walking of the animals, it is proposed that the cowshed arrangement have a cleaning device for cleaning the bedding areas and/or the pathways. Preferably the bedding areas are cleaned with the cleaning device. If the gangways, pathways or generally speaking the walking area of the animals has no structures that are suitable for automatic manure removal, then the walking area is also cleaned by the cleaning device. The cleaning is done here preferably with at least one rotating cleaning unit. The rotating cleaning unit can consist, for example, of a brush. The brush loosens the dirt and pushes it to the side.

In addition to or instead of a rotating cleaning unit, the cleaning device may also have at least one sweeper. Such a sweeper is especially advantageous when the gangways or pathways are built as flatly attached running surfaces made of concrete or asphalt. In the case of flatly attached gangways the surface must be flat and not slippery. With the aid of regular pushing off it is ensured that the running surfaces are as dry and clean as possible. Polluting matter is thereby reduced and the antiskid property is increased to promote the safety of the animals.

A cowshed arrangement in which the cleaning unit and the sweeper are arranged relative to one another so that the sweeper takes up the dirt loosened by the cleaning unit is especially advantageous. Through this measure, an increased cleaning effectiveness is achieved. Hereby, the cleaning unit can be arranged at an angle with respect to the sweeper so that the sweeper is on the side of the cleaning unit. The cleaning unit, which is preferably a rotating brush, can clean the bedding area of the animals, while the sweeper can remove dirt from the gangway or gangways. The sweeper as such may comprise several sweeper elements, whereby the sweeper elements are assigned to the individual gangways.

In order to remove the dirt, dirt transport channels can be provided in the floor of the cowshed arrangement into which the dirt falls and from there is transported away. The dirt transport channels run preferably in the radial direction and are especially arranged equidistant to one another. Alternatively, the dirt can be transported away with a transport device. Here the transport device can operate according to the suction method so that a suction unit is provided next to the cleaning unit and/or the sweeper with which the dirt is aspirated and transported away.

In order to avoid collisions of the cleaning unit with the animals during the cleaning process, it is provided that the cleaning unit run after the driving unit. Hereby the cleaning unit can be designed so that it travels preferably synchronously with the driving device. This is not absolutely necessary. The cleaning device can also be operated independently of the driving device, whereby the cleaning device and/or the driving device have sensors which ensure that when the driving device stops the cleaning device will not collide with the driving device. The sensors can be, for example, approach sensors. If it is determined by the approach sensors that the distance between the driving unit and the cleaning unit is less than a minimum distance, then the speed with which the cleaning unit is moved can be reduced. The cleaning unit can also be stopped when the distance is less than a certain set value.

Thus, the cleaning unit and the driving unit can be moved independently of one another. A simplification of the construction as well as the control-technological expenditure can nevertheless be achieved when the driving unit and the cleaning unit form one structural unit. Hereby the cleaning unit is coupled rigidly to the driving unit so that the cleaning unit and the driving unit have only one operating unit for moving the structural unit. If the cleaning unit and the driving unit are coupled with one another, then the number of cleaning processes preferably corresponds to the number of driving processes. If this is not desirable, then, for example, the cleaning unit can be designed so that it can be swiveled around an essentially vertical axis so that the cleaning unit can be flipped up.

For further simplification of the working processes within the cowshed arrangement according to the invention, it is proposed that a litter device be provided for distributing the litter. The litter device distributes the litter especially in the bedding area. As a result of the litter distribution, undisturbed and clean bedding of the animals is achieved in the bedding area. Furthermore, contamination of the animals with manure on the bedding surfaces is largely avoided. The litter distribution device preferably operates automatically. Hereby there is a possibility to adjust the amount of litter per bedding area correspondingly. The litter can be straw or wood chips. The littering process preferably is performed after a cleaning process was performed. For this purpose, the littering device runs after the cleaning device. The cleaning device and the littering device can form a single structural unit.

Especially it is proposed that the littering device be coupled to the driving device. Such a coupling is especially advantageous when the cleaning device is also coupled with the driving device, but this is not absolutely necessary.

For the purpose of the safety of the animals and personnel, as well as to increase the effectiveness of the operation of the cowshed arrangement, it is proposed that a control and/or regulating device be provided. With the aid of the control and/or regulating device, the working processes performed by the machines within the cowshed arrangement are controlled or regulated. The control or regulation can also take into consideration data of individual animals or data from herd management.

The cows can be driven from the bedding stalls by the bedding stall cleaning brush. This can occur as follows: the brush (or a part of the brush) moves toward the cow. As a rule, all (healthy) cows already stand up and leave the stall when the brush comes near them. When a cow remains lying down, the brush touches the cow, which then, as a rule, at this point at the latest stands up. After touching (measurement by a sensor) the brush moves backwards and a new attempt follows with an adjustable delay. The maximum number of attempts can also be pre-set. When the animal still does not leave the stall, the corresponding brush segment flips to the side (or upward or similar) and moves past the cow. An identification system (for example, on the brush holder) identifies the cow and informs the operator by means of an entry in the error protocol and, as appropriate, through an alarm message, email, SMS or similar. Evaluation of the stored data can follow for monitoring health.

According to a still further advantageous embodiment of the cowshed arrangement, it is proposed that the bedding areas lie on the imaginary sides of at least one polygon. Hereby, we are preferably dealing with an equilateral polygon. Thus, for example, the stall arrangement may have first bedding areas which are on the imaginary sides, for example, of a first octahedron [sic—should be octagon-translator], and the second bedding areas are on the sides of a second octahedron, whereby the first octahedron and the second octahedron have essentially one common midpoint which is preferably in the central region. A compact structure of the cowshed arrangement can be achieved by the fact that the bedding areas are arranged essentially concentrically to the central region.

According to an even more advantageous embodiment of the cowshed arrangement, it is proposed that at least the bedding areas be arranged in at least two levels. For cost-effective design of the cowshed arrangement, it is proposed that it have a high-pitched roof.

According to a further inventive idea, a cowshed unit comprising at least two cowshed arrangements is proposed, whereby the cowshed arrangements are designed in a honeycomb shape. Especially it is proposed that at least two cowshed arrangements have a common milk chamber. At least one milk tank is arranged in the milk chamber, where the milk coming from the milking area is collected and stored.

In all further developments described above it can be possible that a tunnel passage be provided. As a result of the tunnel passage, the particular milking station can be reached from underneath without crossing the path of the animals or otherwise hindering them. With this tunnel passage it is possible to reach the technical installations at the milking stations which then can also be partially arranged below the level of the milking station in the subway (for example, all loud equipment). Instead of a tunnel passage, a bridge can also be provided.

A tower can be provided in the central region from which the installation and the entire cowshed can be surveyed. A central or decentralized control can also be provided there.

When the stall is to be cleaned thoroughly (for example when there is no animal in the stall), the driving unit can be provided with a spray system with which the floor of the stall can be scoured, for example, at a 2-hour repetition rate.

Preferably in the “normal” cleaning operation only dry cleaning is provided whereby the cleaning brushes can be self-cleaning or can be cleaned in a cleaning brush cleaning device.

In the case of several cowshed arrangements a central milk tank can be provided (or also a central [feed] supply).

Other advantages and details of the invention will be explained with the aid of practical examples shown in the drawing without the object of the invention being limited to the specific practical examples.

The following are shown:

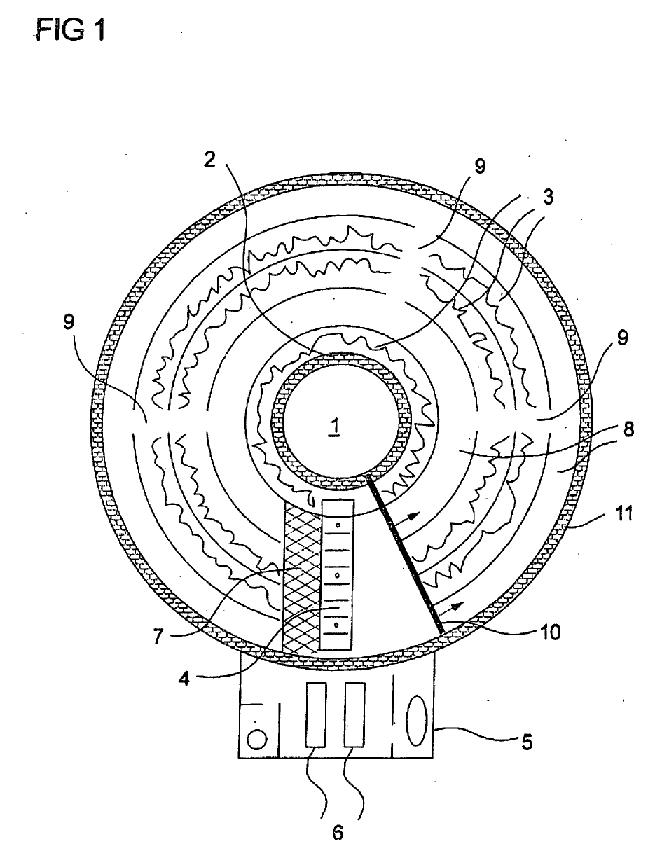

FIG. 1: a first practical example of a cowshed arrangement in a top view,

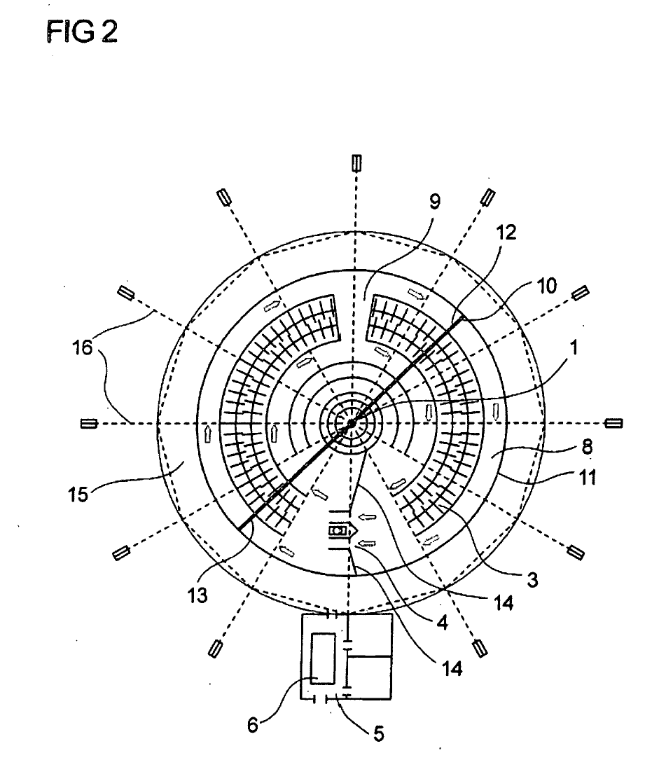

FIG. 2: schematic illustration of a second practical example of a cowshed arrangement in top view,

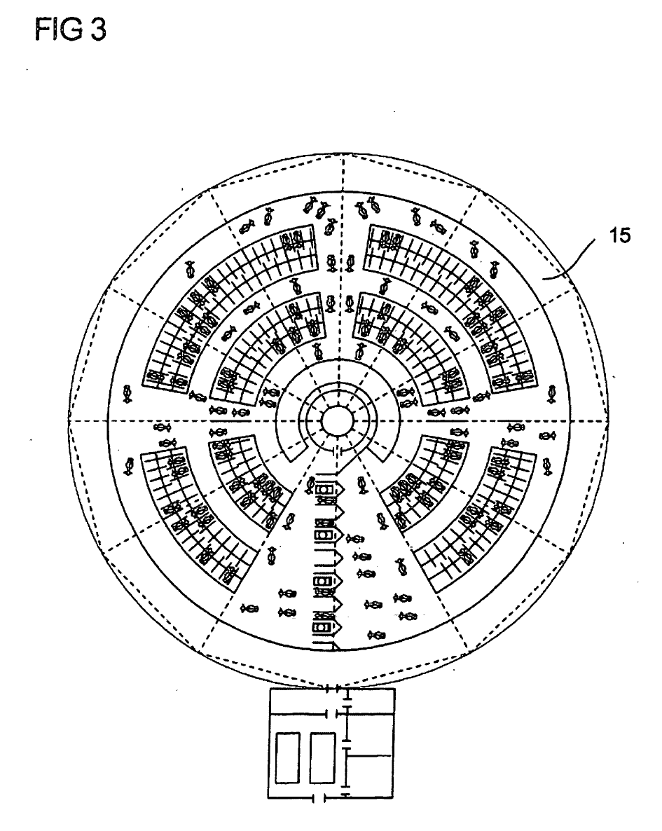

FIG. 3: a third practical example of a cowshed arrangement in a top view,

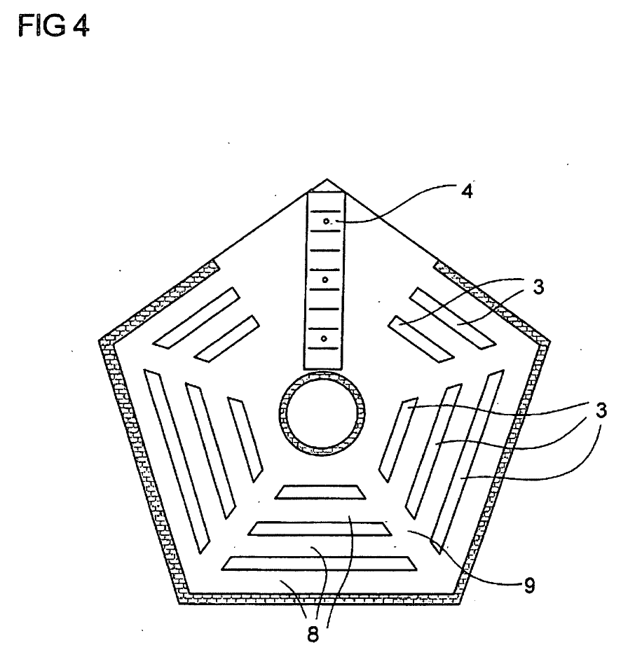

FIG. 4: a schematic illustration of a pentagonal cowshed arrangement in top view,

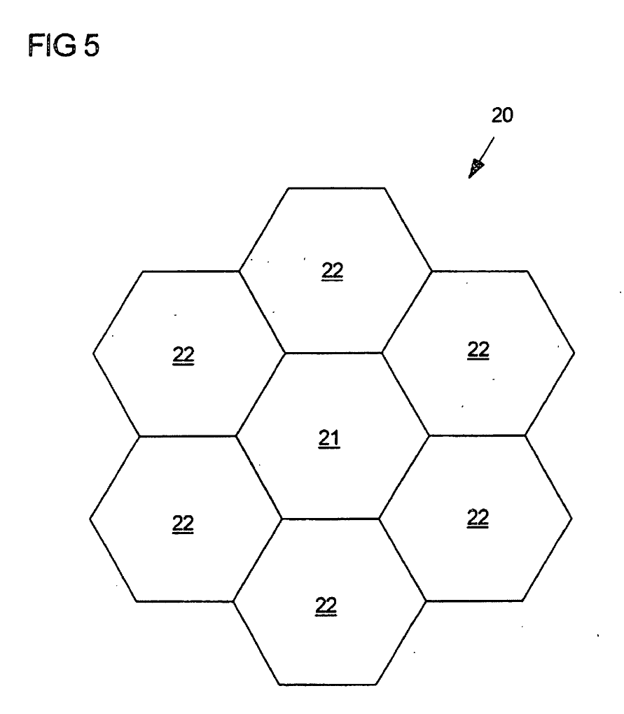

FIG. 5: schematic illustration of a honeycomb-shaped cowshed installation in a top view,

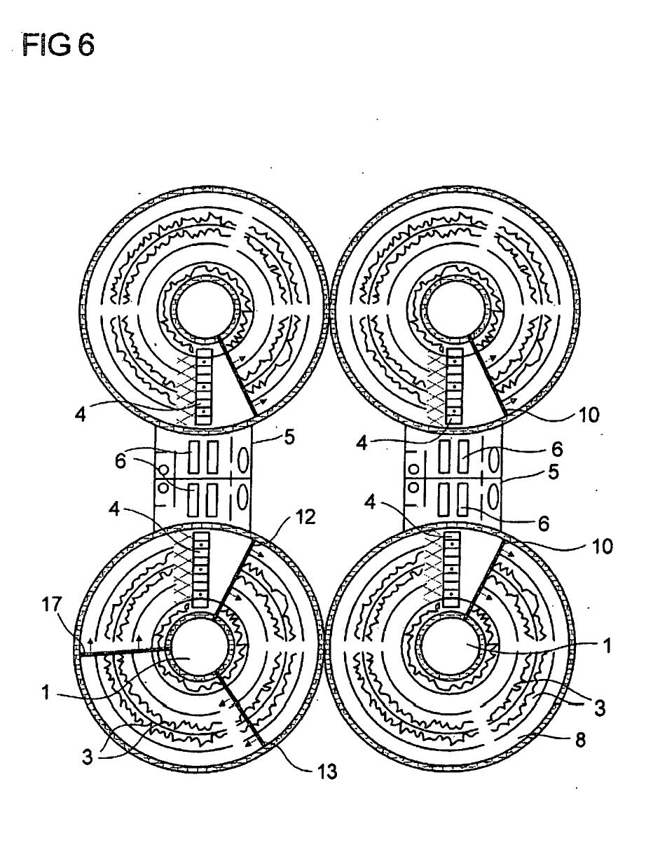

FIG. 6: a second practical example of a stall installation in a top view.

FIG. 1 shows schematically in a top view a first practical example of a cowshed arrangement. The cowshed arrangement shown in FIG. 1 has a circular ground plan. It has a central region 1.

This central region 1 can be designed in the form of a tower. The tower can have several floors. The individual floors can be assigned different functionalities. For example, in the lower part of the tower the technical equipment can be arranged. The technical equipment can be control and regulating units, data processing units, supply lines as well as other technical means which are necessary for the operation of the cowshed operation or with the operation of the cowshed arrangement.

The tower can be reached through a tunnel, one end of which is outside the cowshed arrangement. In another floor of the tower, for example, an office and a central monitoring station can be installed. For this purpose it is advantageous when the tower is designed so that an operator has free view preferably over the entire cowshed arrangement. For this purpose the tower can have the corresponding glass walls. A control pathway 2 is provided around the tower.

The cowshed arrangement has bedding areas 3. The bedding areas 3 are arranged around the central region 1. The bedding areas 3 are arranged concentrically to the central region 1. The bedding areas can be designed as deep stalls with litter or as high stall with mat, optionally with a slight litter for lying comfort and stepping safety. To facilitate lying down, resting and standing up without hindrance, the stalls in the bedding area are generous in dimension in the bedding area and are separated from one another as appropriate for the animal. The separation can be done with railings. This is not absolutely necessary. The bedding areas 3 can also be formed without separation into stalls, which simplifies the automatic cleaning of the cowshed arrangement significantly.

For the purpose of milking, the animals located in the cowshed arrangement have a milking area 4 provided for them which extends essentially in a radial direction. In the practical example shown, the milking area is equipped with three double stall installations with automatic milking system.

The tunnel, constructed so that it extends radially outward from the central region I runs preferably below the milking area 4 so that the individual milking stations of milking area 4 can be reached through the tunnel.

In order to collect the milked milk, this is led through a piping system, which is not shown, into a milk chamber 5. The milk chamber 5 has tanks, especially cooling tank 6. The piping system which is not shown opens into the cooling tank so that the milked milk can arrive into these. An outlet into the tunnel can also be located in milking chamber 6 [sic, should be 5]. The piping system which goes from the milking area to the tanks, especially to cooling tank 6, is preferably arranged in the tunnel, which is not shown.

The milking area 4 can also be equipped with passages, which are not shown, so that the animals can go through the milking area 4 without being milked.

A selection sector 7 is arranged in the inlet region of milking area 4 and this is shown schematically in FIG. 1 in a shaded manner. The selection sector 7 serves for selecting animals which have been classified as being ready to be milked or not ready to be milked, respectively. The formation of a selection sector 7 is not absolutely necessary.

In order to allow free movement of the animals within the cowshed arrangement, gangways 8 are provided. The gangways are arranged concentrically to the central region 1. The width of the gangways 8 is designed so that the animals can pass one another without fear of higher-ranking animals. In order to further enhance the possibility of movement of the animals as well as to simplify the design of the cowshed arrangement, pathways 9 are provided. The pathways 9 extend in a radial direction whereby the pathways 9 connect the gangways 8 with one another. Preferably one pathway 9 is provided per twelve to fifteen bedding stalls or bedding areas, respectively. As a result of this measure, the animals have the possibility of avoiding one another.

The cowshed arrangement shown in FIG. 1 has a driving device 10. The driving device 10 in the practical example shown can be turned around the central region in the mathematical sense. The driving device 10 extends from the central region 1 to an edge region 11 of the cowshed arrangement.

The driving device is operated as a function of the set speed. Preferably the driving device passes through the cowshed arrangement once every eight hours. The speed with which the driving device is driven through the cowshed can be controlled or regulated. The driving device 10 and the milking area 4 are designed so that the driving device can be moved past the milking area. Preferably this is achieved by guiding the driving device above the milking area. For this purpose the driving device has at least one guide. The guide extends preferably over the entire path of the driving device.

Once the driving device has gone around once then all the cows have been milked. As a function of the position of the driving device, individual or several process steps can be triggered in the milking area, especially in an automatic milking system. Thus, for example, the rinsing of the milking system can be activated by the driving device as a function of its position. For example, during the rinsing time the driving device swings up above the milking area and begins a new circuit behind the milking area.

In order to clean the gangways, pathways and/or bedding areas, preferably a cleaning device is provided.

At least one feeding area is provided for feeding the animals in the edge region. It is expedient when next to the milking area 4 the animals are provided the possibility to take in water so that the animals can drink after milking without having to go a long distance.

FIG. 2 shows a schematic top view of a second practical example of a cowshed arrangement. The structural design of this cowshed arrangement corresponds essentially to the design of the cowshed arrangement according to FIG. 1. The cowshed arrangement according to FIG. 2 also has a milking chamber 5. Within the cowshed arrangement there is a driving device 10 which is moved around the central region 1. The driving device has two driving units 12, 13. The driving units 12, 13 form an angle of 180°. The milking area 4 extends in the radial direction from the central region to the edge region 11. It has separating walls 14 which prevent the animals from passing through the milking area without being milked.

Cows are very adaptable to temperature exposure. They are less sensitive to minus temperatures than to high summer temperatures. Thus, they are well attended in uninsulated buildings with large air volume. A roof which keeps the rain away and casts shadow and wall structures that provide protection against the wind are sufficient. In the practical example of the cowshed arrangement shown, it has a high-pitched roof 15 which is spanned and held above tension cables 16. The high-pitched roof also covers a feed table provided in edge region 11.

Preferably the cowshed arrangement has at least one identification device which is intended for the identification of individual animals. With the aid of the identification device the animals which are being milked can be recognized. There is also a possibility that in the case of animals which do not have to have a predetermined number of milking processes within a specific time span can be passed through the milking area without a milking process occurring.

By the design of the cowshed arrangement according to the invention the possibility is created to extend the cowshed arrangement by addition of bedding areas and/or milking areas to provide a cowshed arrangement which is suitable for a larger number of animals.

FIG. 3 shows schematically a cowshed arrangement which corresponds conceptually essentially to the cowshed arrangement according to FIG. 2. However, the cowshed arrangement according to FIG. 3 is suitable for holding a larger number of animals. By the addition of individual or several arc-shaped bedding areas, the cowshed arrangement can be expanded further.

The cowshed arrangement according to the invention is not limited to cowshed arrangements which have an essentially circular basic structure. There is also the possibility to design cowshed arrangements which have a polygonal ground plan. FIG. 4 shows a practical example of a cowshed arrangement which is designed based on a pentagonal ground plan. This cowshed arrangement has a central region 1. Bedding areas 3 are provided around the central region 1. The bedding areas 3 lie on the imaginary sides of a pentagon. Looking in the radial direction, a milking area 4 is provided.

The animals which are located within the cowshed arrangement can move along the gangways 8 and pathways 9. With the aid of a driving device which is not shown, the animals are driven to the milking area 4 preferably periodically.

FIG. 5 shows schematically a cowshed unit 20. The cowshed unit 20 is designed in a honeycomb shape in the practical example shown. It has a central unit 21 which is surrounded by cowshed arrangements 22. For example, the central unit may hold the entire technical equipment which is necessary for the operation of the cowshed arrangements 22. Thus, for example, a cooling tank of the cowshed arrangements 22 can be located in the central unit. A relatively compact structure is achieved by the honeycomb structure of the cowshed unit.

FIG. 6 shows a second practical example of a cowshed unit. The cowshed unit 20 has cowshed arrangements 22. The cowshed arrangements 22 have the basic design corresponding to the cowshed arrangement shown in FIG. 1. One of the cowshed arrangements 22 has a driving device which is provided with three driving units 12, 13, 17. The driving units 12, 13, 17 are arranged equidistant from one another.

### REFERENCE LIST

1 Central region
2 Control gangway
3 Bedding area
4 Milking area
5 Milk chamber
6 Cooling tank
7 Selection sector
8 Gangway
9 Pathway
10 Driving device
11 Edge region
12, 13 Driving unit
14 Separating wall
15 High-pitched roof
16 Tension cable
17 Driving unit
20 Cowshed unit
21 Central unit
22 Cowshed arrangement

1. Cowshed arrangement with a central region (1) and with bedding areas (3) which are arranged around the central region (1) as well as with a milking area (4), characterized by the fact that at least one milking area (4) extends essentially in a radial direction.

2. Cowshed arrangement according to claim 1, characterized by the fact that the milking area (4) has at least one automatic milking system.

3. Cowshed arrangement according to claim 1, characterized by the fact that the milking area (4) has at least one passage.

4. Cowshed arrangement according to claim 3, characterized by the fact that the passage has at least one gate which is opened and closed automatically.

5. Cowshed arrangement according to one of claims 1 to 4, characterized by at least one selection sector 7.

6. Cowshed arrangement according to one or several of the previous claims, characterized by the fact that at least one identification device is provided, which is intended for the identification of individual animals.

7. Cowshed arrangement according to claim 6, characterized by the fact that at least one milking area (4) and/or passage and/or the selection sector (7) has at least one identification device.

8. Cowshed arrangement according to one of claims 1 to 7, characterized by the fact that this has at least one gangway (8) extending essentially in the peripheral direction.

9. Cowshed arrangement according to one of claims 1 to 8, characterized by the fact that this has a pathway (9) extending essentially in the radial direction which preferably connects two gangways (8).

10. Cowshed arrangement according to one of claims 1 to 9, characterized by the fact that at least one feeding area is provided, which is arranged, for example, between two neighboring bedding areas (3) or in the edge region (11) of the cowshed arrangement, whereby the feeding area preferably has an automatic feed dispensing device.

11. Cowshed arrangement according to at least one of claims 1 to 10, characterized by the fact that a waiting area is provided before the milking area.

12. Cowshed arrangement according to one of claims 1 to 11, characterized by the fact that a driving device (10) is provided.

13. Cowshed arrangement according to claim 12, characterized by the fact that at least one milking area (4) and the driving device (10) can be moved relative to one another.

14. Cowshed arrangement according to claim 13, characterized by the fact that at least one milking area (4) is in a fixed location and the driving device (10) is movable, or that at least one milking area (4) can be moved and the driving device (10) is in a fixed location.

15. Cowshed arrangement according to claim 14, characterized by the fact that the driving device (10) has at least one driving unit (12, 13, 17) which can be moved around the central region (1) in the peripheral direction, especially it is rotatable whereby the driving unit (12, 13, 17) is preferably guided in at least one guide.

16. Cowshed arrangement according to one of claims 12 to 15, characterized by the fact that the driving device (10) has at least one, especially controllable driving unit.

17. Cowshed arrangement according to one of claims 12 to 16, characterized by the fact that the driving device (01) (translator's note: should be 10) and/or at least one milking area (4) is or are designed in such a way that the driving device (10) and at least one milking area (4) can be moved past one another.

18. Cowshed arrangement according to one of claims 1 to 17, characterized by the fact that a cleaning device is provided which is preferably automatic.

19. Cowshed arrangement according to claim 18, characterized by the fact that the cleaning device has at least one rotating cleaning unit.

20. Cowshed arrangement according to claim 18 or 19, characterized by the fact that the cleaning device has at least one sweeper.

21. Cowshed arrangement according to claim 20, characterized by the fact that the cleaning unit and the sweeper are arranged with respect to one another in such a way that the sweeper picks up the dirt loosened by the cleaning unit.

22. Cowshed arrangement according to one of claims 18 to 21, characterized by the fact that a transport device is provided with which the dirt is carried away.

23. Cowshed arrangement according to one of claims 18 to 22, characterized by the fact that the cleaning device and the driving device form one structural unit.

24. Cowshed arrangement according to one of claims 1 to 23, characterized by the fact that a preferably automatic littering device is provided for distributing the litter.

25. Cowshed arrangement according to claim 24, characterized by the fact that the littering device is coupled to the driving device.

26. Cowshed arrangement according to one of claims 1 to 5, characterized by the fact that a control and/or regulating unit is provided.

27. Cowshed arrangement according to one of claims 1 to 26, characterized by the fact that the bedding areas (3) are on the imagined side of at least one preferably equilateral polygon.

28. Cowshed arrangement according to one of claims 1 to 26, characterized by the fact that the bedding areas (3) are arranged essentially concentrically to the central region (1).

29. Cowshed arrangement according to one of claims 1 to 28, characterized by the fact that at least the bedding areas are provided on two levels.

30. Cowshed arrangement according to one of claims 1 to 29, characterized by the fact that this has a high-pitched roof.

31. Cowshed unit comprising at least two cowshed arrangements according to one of claims 1 to 30, whereby the cowshed arrangements are arranged in a honeycomb pattern.

32. Cowshed unit according to claim 31, characterized by the fact that at least two cowshed arrangements have a common milking chamber (5).
